(19) United States
(12) Patent Application Publication
(10) Pub. No.: US 2015/0118412 A1
(43) Pub. Date: Apr. 30, 2015

(54) DEVICE AND METHOD TO FORM PROTECTIVE COATING

(71) Applicant: HON HAI PREISION INDUSTRY CO., LTD., New Taipei (TW)

(72) Inventor: HAN-LUNG LEE, New Taipei (TW)

(21) Appl. No.: 14/526,550

(22) Filed: Oct. 29, 2014

(30) Foreign Application Priority Data
Oct. 29, 2013 (TW) 102139171

(51) Int. Cl. B05D 3/06; B05C 5/02; B05D 3/00

(52) U.S. Cl. CPC B05D 3/067; B05D 3/007; B05C 5/02
USPC 427/553; 118/620

(57) ABSTRACT

Device configured to form a protective film includes a receiving unit made of transparent material, an attracting unit, and an UV curing unit. The receiving unit defines a receiving groove configured to locate and hold an uncoated component. A shape of the receiving groove is same as that of the uncoated component, and a size of the receiving groove is greater than that of the uncoated component. The attracting unit is configured to attract and hold the component as it is coated with protective glue. The UV curing unit is arranged below the receiving unit to cure the glue with UV light to form a protective coating. A method to form a protective film is also provided.

### FIELD

The present disclosure relates to protective coatings.

### BACKGROUND

Usually, a protective coating is formed on a surface of a component of an electronic product to protect the surface of the component.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a cross-sectional view of a device to form a protective coating according to a first embodiment.

FIG. 2 is a flow chart of a method to form a protective coating according to a second embodiment.

FIG. 3 illustrates a cross-sectional view of a component adsorbed and received in a groove according to the second embodiment.

FIG. 4 illustrates a cross-sectional view of infilling the groove with glue.

FIG. 5 illustrates a cross-sectional view of the component coated with a a protective coating released from the groove in FIG. 4, according to the second embodiment.

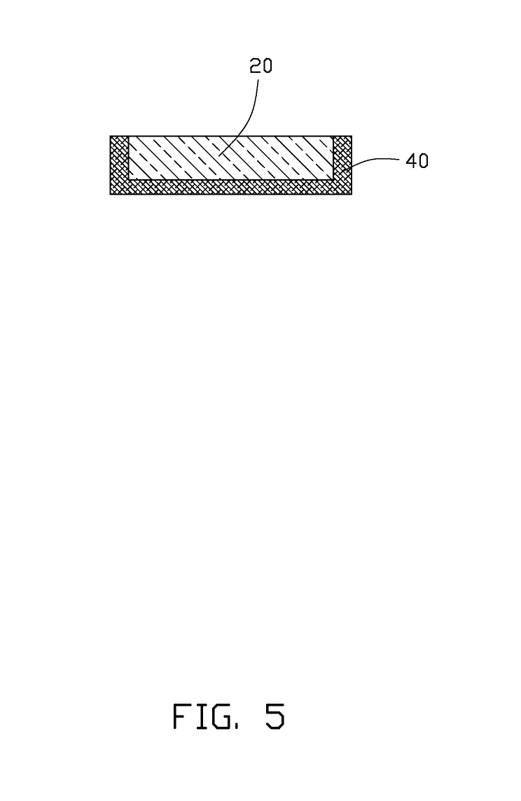

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

A device to form a protective coating includes a receiving unit, an attracting unit, and a UV curing unit. The receiving unit is made of transparent material. The receiving unit defines a receiving groove configured to receive a component. A shape of the receiving groove is same as that of the component to be received, but a size of the receiving groove is greater than that of the component. The attracting unit configured to attract and hold the component in the receiving groove. The attracting unit defines at least one feed hole corresponding to edges of the receiving groove. The at least one feed hole is configured to provide glue to the receiving groove. The UV curing unit is arranged below the receiving unit and configured to emit UV light.

A method to form a protective coating includes the followings. A device to form a protective coating is provided. The device to form a protective coating includes a receiving unit, an attracting unit, and a UV curing unit. The receiving unit is made of transparent material. The receiving unit defines a receiving groove configured to receive a component. A shape of the receiving groove is same as that of the component to be received, but a size of the receiving groove is greater than that of the component. The attracting unit configured to attract and suspend the component in the receiving groove. The attracting unit defines at least one feed hole corresponding to edges of the receiving groove. The at least one feed hole is configured to provide glue to the receiving groove. The UV curing unit is arranged below the receiving unit and configured to emit UV light beams. A component is attracted by the attracting unit. Then, the attracted component is held in the receiving unit. A space between the component and inner walls of the receiving groove is formed when the component is held in the receiving groove. The space is infilled with glue through the at least one feed holes, and the glue is cured by the UV curing unit to form a protective coating on surfaces of the component.

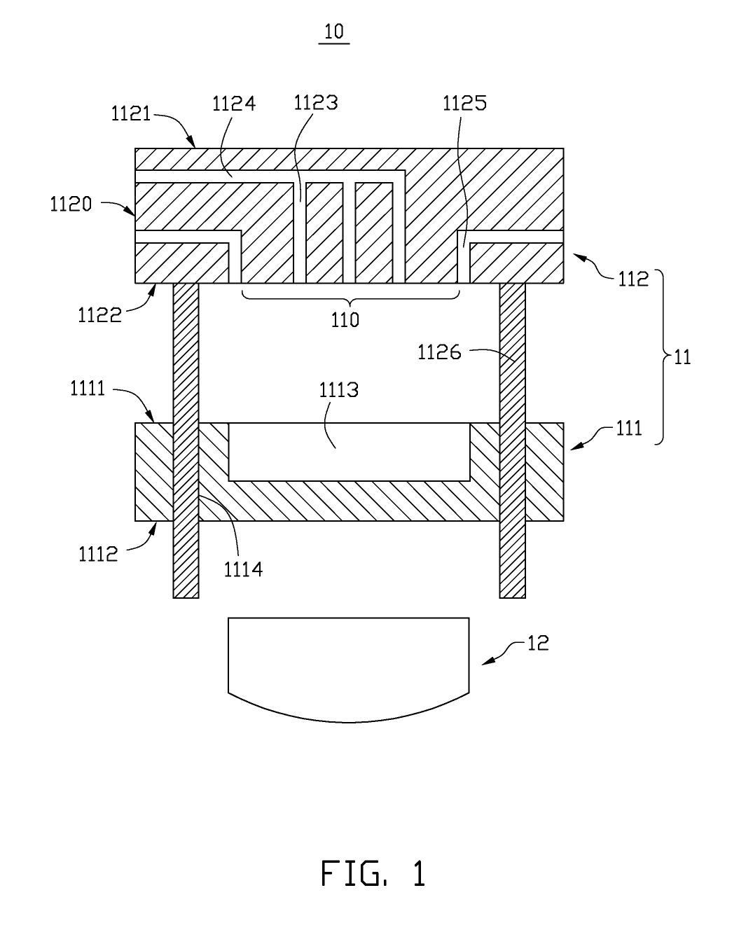

FIG. 1 illustrates a first embodiment of a device 10 configured to form a protective coating which includes a receiving unit 111, an attracting unit 112, and an ultraviolet (UV) curing unit 12.

The receiving unit 111 is made of transparent material, such as transparent resin or transparent glass, to allow the passage of light, especially UV light. The receiving unit 111 includes a first surface 1111 and a second surface 1112 opposite to and substantially parallel to the first surface 1111. The receiving unit 111 defines a receiving groove 1113 and a plurality of through holes 1114.

The receiving groove 1113 is defined from the first surface 1111 inwards into the receiving unit 111. The receiving groove 1113 is configured to receive a component. A shape of the receiving groove 1113 is same as that of the component to be received. A size of the receiving groove 1113 is greater than that of the component. In this embodiment, the shape of the component is rectangular, so the shape of the receiving groove 1113 is also rectangular. A release layer (not shown) is formed on inner walls 1115 of the receiving groove 1113 by a plating process or a spraying process. In other embodiments, the receiving unit 111 can define two or more receiving grooves 1113 to receive two or more components.

The through holes 1114 pass through the first surface 1111 and the second surface 1112. The through holes 1114 are positioned so as to surround the receiving groove 1113.

The attracting unit 112 is configured to attract and position the component. The attracting unit 112 includes a top surface 1121, a bottom surface 1122 opposite to the top surface 1121, and side surfaces 1120 between the top surface 1121 and the bottom surface 1122. The bottom surface 1121 includes an adsorbing area 110 corresponding to the receiving groove 1113.

The attracting unit 112 defines a plurality of adsorbing holes 1123, a suction hole 1124, and two feed holes 1125. The adsorbing holes 1123 are defined from the adsorbing area 110 of the bottom surface 121 inwards into the attracting unit 112, and are configured to attract and hold components. The suction hole 1124 is defined from one side surface 1120 inwards into the attracting unit 112, and all of the adsorbing holes 1123 intercommunicate. A vacuum pump (not shown) connects to the suction hole 1124. Each of the feed holes 1125 passes through the adsorbing area 110 of the bottom surface 121 and one side surface 1120. The feed holes 1125 are corresponding to the edges of the receiving groove 1113. The feed holes 1125 are configured to allow glue to flow through the attracting unit 112 into the receiving groove 1113. In another embodiment, the suction hole 1124 can also be defined from the top surface 1121 inwards into the attracting unit 112, and the feed holes 1125 can also pass through the adsorbing area 110 of the bottom surface 121 and the top surface 1121. The number of the feed holes 1125 can be one or more than two.

The attracting unit 112 further includes a plurality of poles 1126 protruding from and substantially perpendicular to the bottom surface 1122. The poles 1126 correspond to the through holes 1114. Each of the poles 1126 can pass through a through hole 1114 to locate and connect the receiving unit 111 and the attracting unit 112 together. A plurality of threaded portions (not shown) can be formed on a end of the pole 1126 away from the bottom surface 1122, and fasteners (not shown) can be used to engage with the poles 1126 to lock the receiving unit 111 on the attracting unit 112.

In other embodiments, the poles 1126 and the through holes 1114 can be replaced by latches or clips or other locking elements to fix the receiving unit 111 and the attracting unit 112 together.

The UV curing unit 12 is arranged below the receiving unit 111 and faces the second surface 1112. The UV curing unit 12 includes an UV light source and is configured to emit UV light.

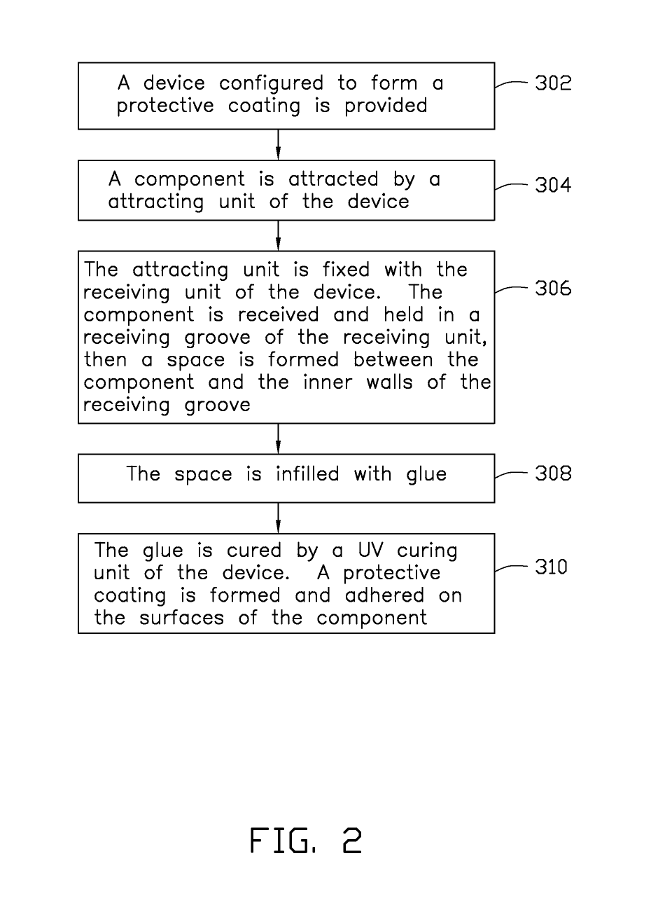

Referring to FIG. 2, a flowchart is presented in accordance with an example embodiment. The example method 30 is provided by way of example, as there are a variety of ways to carry out the method. The method 20 described below can be carried out using the configurations illustrated in FIG. 1, for example, and various elements of these figures are referenced in explaining example method 30. Each block shown in FIG. 2 represents one or more processes, methods, or subroutines, carried out in the exemplary method 30. Additionally, the illustrated order of blocks is by example only and the order of the blocks can change. The exemplary method 30 can begin at block 302.

At block 302, a device configured to form a protective coating is provided.

The device is same as the device in the first embodiment.

At blocks 304, a component is attracted by a attracting unit of the device.

At blocks 306, the attracting unit is fixed with the receiving unit of the device, and the component is received and held in a receiving groove of the receiving unit, a space is formed between the component and the inner walls of the receiving groove.

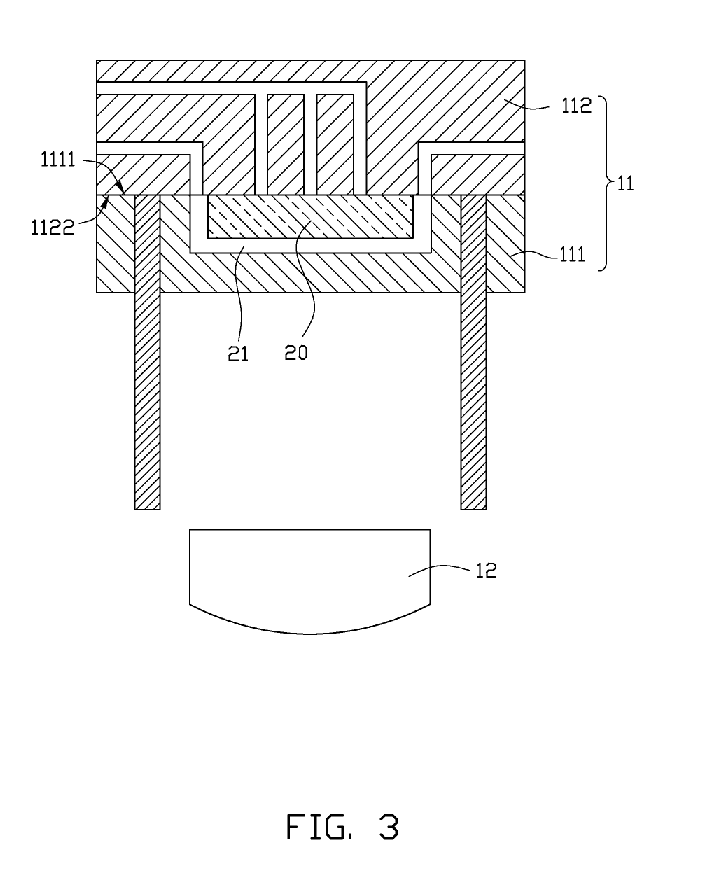

FIG. 3 illustrates that a component 20 is attracted onto the adsorbing area 110 of the bottom surface 1122 by the attracting unit 112, and the attracting unit 112 is fixed with the receiving unit 111, and the component 20 is received and held in the receiving groove 1113. Each of the poles 1126 passes through a through hole 1114, then fasteners (not shown) are used to engage with the poles 1126 to lock the receiving unit 111 on the attracting unit 112. The bottom surface 1122 of the attracting unit 112 is in contact with the first surface 1111 of the receiving unit 111. A surface of the component 20 is substantially coplanar with the first surface 1111; a space 21 thus is formed between the component 20 and the inner walls 1115 of the receiving groove 1113. The space 21 is in communication with the two feed holes 1125.

At blocks 308, the space is infilled with glue.

At blocks 310, the glue is cured by a UV curing unit of the device. A protective coating is formed and adhered on the surfaces of the component.

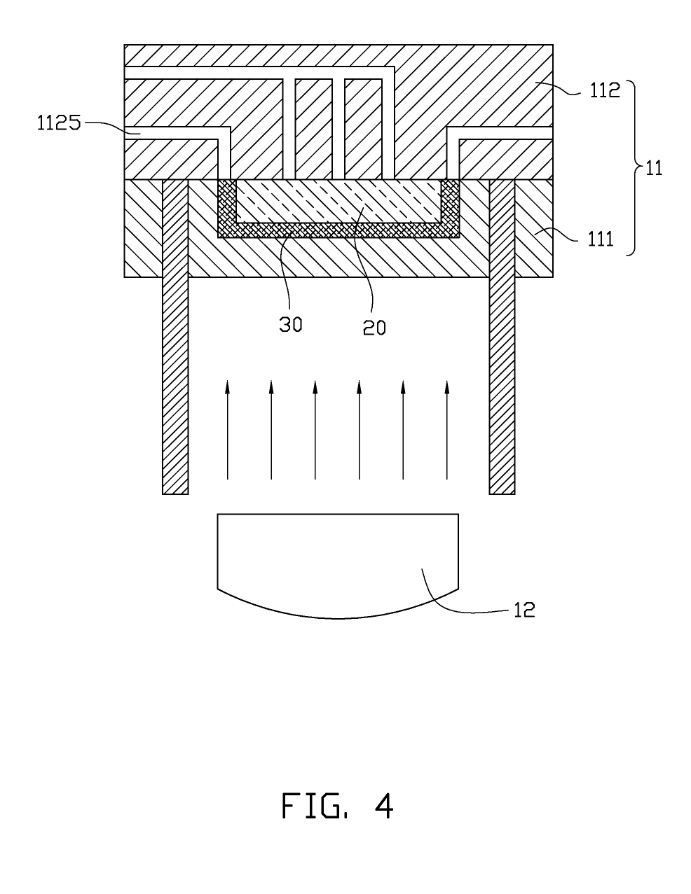

FIG. 4 illustrates that the space 21 is infilled with glue 30 through the two feed holes 1125, and the glue 30 then is cured by the UV curing unit 12.

Since the receiving unit 111 is made of transparent material, UV light from the UV curing unit 12 are able to pass through the receiving unit 111 to irradiate and cure the glue 30 in the space 21.

FIG. 4 illustrates that the cured glue 30 on the surface of the component 20 forms the protective coating 40, and the component 20 coated by the protective coating 40 is released from the receiving groove 1113.

A thickness of the protective coating 40 is equal to a thickness of the space 21, that is, a required thickness of the protective coating 40 on the component 20 can be achieved by a corresponding sizing of the receiving groove 1113.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A device to form protective coatings, comprising:
a receiving unit made of transparent material and defining a receiving groove configured to receive a component;
an attracting unit configured to attract and hold the component in the receiving groove, the attracting unit defining at least one feed hole corresponding to edges of the receiving groove, wherein the at least one feed hole is configured to provide glue to the receiving groove; and
a UV curing unit arranged below the receiving unit and configured to emit UV light.

2. The device to form protective coatings of claim 1, wherein the attracting unit has a adsorbing area corresponded to the receiving groove, the attracting unit defines a plurality of adsorbing holes on the adsorbing area and a suction hole in communication with all the adsorbing holes, the suction hole is configured to connect a vacuum pump.

3. The device to form protective coatings of claim 2, wherein the attracting unit comprises a top surface, a bottom surface opposite to the top surface, and side surfaces between the top surface and the bottom surface, the adsorbing holes are defined from the adsorbing area of the bottom surface inwards into the attracting unit, the suction hole is defined from one of the side surface or the top surface inwards into the attracting unit.

4. The device to form protective coatings of claim 1, wherein the attracting unit defines two feed holes configured to allow glue to flow through, the two feed holes are at edges of the receiving groove.

5. The device to form protective coatings of claim 1, further comprising a locking element configured to fix the receiving unit and the attracting unit together.

6. The device to form protective coatings of claim 5, wherein the locking element comprises a plurality of through holes defined in the receiving unit and a plurality of poles protruding from a surface of the attracting unit, the through holes are positioned surrounding the receiving groove, the poles corresponds to the through holes, and are configured to pass through the through holes to connect and fix the receiving unit and the attracting unit together.

7. The device to form protective coatings of claim 1, wherein the receiving unit is made of transparent resin or transparent glass.

8. A method to form protective coatings, comprising:
providing a device to form protective coatings, comprising:
a receiving unit made of transparent material, the receiving unit defining a receiving groove configured to receive a component, a shape of the receiving groove being same as that of the component to be received, but a size of the receiving groove being greater than that of the component;
an attracting unit configured to attract and hold the component in the receiving groove, the attracting unit defining at least one feed hole corresponding to edges of the receiving groove, the least one feed holes configured to provide glue to the receiving groove; and
an UV curing unit arranged below the receiving unit and configured to emit UV light;
attracting a component by the attracting unit;
fixing the attracting unit with the receiving unit, and receiving and holding the component in the receiving groove, therefore forming a space between the component and inner walls of the receiving groove, the at least one feed holes being in communication with the space;
infilling the space with glue through the at least one feed holes; and
curing the glue by the UV curing unit to form and adhere a protective coating on surfaces of the component.

9. The method of claim 8, wherein the attracting unit has a adsorbing area corresponded to the receiving groove, the attracting unit defines a plurality of adsorbing holes on the adsorbing area and a suction hole in communication with all the adsorbing holes, the suction hole is configured to connect a vacuum pump, in the step of attracting a component by the attracting unit, the component is attracted onto the adsorbing area.

10. The method of claim 9, wherein the attracting unit comprises a top surface, a bottom surface opposite to the top surface, and side surfaces between the top surface and the bottom surface, the adsorbing holes are defined from the adsorbing area of the bottom surface inwards into the attracting unit, the suction hole is defined from one of the side surface or the top surface inwards into the attracting unit.

11. The method of claim 8, wherein the attracting unit defines two feed holes, the two feed holes are at edges of the receiving groove, after fixing the attracting unit with the receiving unit, the space is in communication with the two feed holes, and the space is infilled with glue through the two feed holes.

12. The method of claim 8, wherein the device to form protective coatings further comprises a locking element configured to fix the receiving unit and the attracting unit, in the step of fixing the attracting unit with the receiving unit, the attracting unit is fixed with the receiving unit by the locking element.

13. The method of claim 12, wherein the locking element comprises a plurality of through holes defined in the receiving unit and a plurality of poles protruding from a surface of the attracting unit, the through holes are positioned surrounding the receiving groove, the poles corresponds to the through holes, in the step of fixing the attracting unit with the receiving unit, the poles are pass through the corresponding through hole to connect and fix the receiving unit and the attracting unit.

14. The method of claim 8, wherein the receiving unit is made of transparent resin or transparent glass.
